(19) United States
(12) Patent Application Publication
(10) Pub. No.: US 2020/0073159 A1
(43) Pub. Date: Mar. 5, 2020

(54) METHOD FOR PREPARING AN INFRARED REFLECTIVE DEVICE

(71) Applicants: South China Normal University, Panyu District, GUANGZHOU (CN); Shenzhen Guohua Optoelectronics Co., Ltd., SHENZHEN (CN); Academy of Shenzhen Guohua Optoelectronics, Shenzhen (CN)

(72) Inventors: Guofu ZHOU, GUANGZHOU, GUANGDONG (CN); Xiaowen HU, GUANGZHOU, GUANGDONG (CN); Nan LI, SHENZHEN (CN)

(21) Appl. No.: 16/493,633

(22) PCT Filed: Nov. 15, 2017
(86) PCT No.: PCT/CN2017/110988

§ 371 Date: Sep. 12, 2019

(30) Foreign Application Priority Data
May 17, 2017 (CN) 201710348933.3

(51) Int. Cl. G02F 1/1337; G02F 1/1341; G02F 1/1334

(52) U.S. Cl. CPC G02F 1/1337; G02F 1/1341; G02F 2203/11; G02F 2001/13345; G02F 1/1334

(57) ABSTRACT

A method for preparing an infrared reflective device, including: preparing a first and second conductive light-transmitting substrates which are arranged opposite to each other; preparing a parallel alignment layer on a respective surface of each conductive light-transmitting substrate facing to the other; preparing a liquid crystal cell using the two conductive light-transmitting substrates; mixing a negative liquid crystal, a chiral dopant, a liquid crystal monomer and a photoinitiator to obtain a liquid crystal mixture; injecting the liquid crystal mixture into the liquid crystal cell; connecting the first conductive light-transmitting substrate to a negative pole of a power supply assembly, connecting the second conductive light-transmitting substrate to a positive pole of the power supply assembly; and carrying out ultraviolet irradiation to polymerize the liquid crystal monomer so as to form a polymer network with a gradient density distribution in a direction perpendicular to the conductive light-transmitting substrates.

### TECHNICAL FIELD

The present disclosure relates to the technical field of optics and liquid crystal device, and more particularly, to a method for preparing an infrared reflective device.

### BACKGROUND

People usually work indoors and so the comfort of the indoor environment has a great impact on their enthusiasm for work. For this, a cooling or heating device is usually provided indoors and other environments for the purpose of adjusting the temperature to a comfort level.

In order to realize the purpose of transmitting and reflecting sunlight, a glass window is often coated to allow its glass to reflect or transmit light at a certain wavelength. A coated glass is a glass which is coated with one or more layer of metal, alloy or metal compound film on its surface to change optical property thereof so as to achieve the purpose of reflecting or transmitting light at a certain wavelength.

However, the coated glass, once being formed, cannot be changed in its optical property to meet the needs of people.

For the above reasons, there is a need for the market to develop an infrared reflective device.

### SUMMARY

The present disclosure aims at solving the technical problem by providing a method for preparing an infrared reflective device with an adjustable infrared reflection waveband.

According to an aspect of the present disclosure, there is provided a method for preparing an infrared reflective device, including:

S1: preparing a first conductive light-transmitting substrate and a second conductive light-transmitting substrate, the first conductive light-transmitting substrate and the second conductive light-transmitting substrate being arranged opposite to each other;

S2: spin-coating an alignment layer on each of a surface of the first conductive light-transmitting substrate facing the second conductive light-transmitting substrate and a surface of the second conductive light-transmitting substrate facing the first conductive light-transmitting substrate, and performing parallel rubbing alignment;

S3: preparing a liquid crystal cell using the first conductive light-transmitting substrate and the second conductive light-transmitting substrate;

S4: uniformly mixing and heating a negative liquid crystal, a chiral dopant, a liquid crystal monomer and a photoinitiator to obtain a liquid crystal mixture;

S5: injecting the liquid crystal mixture into the liquid crystal cell, the liquid crystal monomer and the chiral dopant enabling the negative liquid crystal to form into a cholesteric helical structure;

S6: connecting the first conductive light-transmitting substrate to a negative pole of a power supply assembly, connecting the second conductive light-transmitting substrate to a positive pole of the power supply assembly, at least of the liquid crystal monomer and the chiral dopant capturing impurity cations in the liquid crystal mixture to be positively charged to move towards the first conductive light-transmitting substrate; and

S7: using ultraviolet light to irradiate the liquid crystal cell, thereby the liquid crystal monomer is initiated by the photoinitiator to be polymerized so as to form a polymer network with a gradient density distribution in a direction perpendicular to the first conductive light-transmitting substrate, the negative liquid crystal being dispersed in the polymer network.

In some embodiments, at least one of the liquid crystal monomer and the chiral dopant has an ester group capable of capturing cation.

In some embodiments, the liquid crystal monomer is at least one of RM82, RM257 and M04031.

In some embodiments, the chiral dopant is at least one of S811, R811, S1011, R1011, ZLI-4572.

In some embodiments, the photoinitiator is Irgacure-651 or Irgacure-369.

In some embodiments, the negative liquid crystal is at least one of MLC-2079, HNG708200-100, HNG30400-200.

In some embodiments, the ultraviolet light irradiates the liquid crystal cell from the first conductive light-transmitting substrate. In some embodiments, both the first conductive light-transmitting substrate and the second conductive light-transmitting substrate include a substrate, and each substrate is coated with a conducting layer on a respective surface facing the other substrate.

The present disclosure has the beneficial effects as follows.

A method for preparing an infrared reflective device with an adjustable infrared waveband is provided according to the disclosure. A liquid crystal cell including two conductive light-transmitting substrates is prepared first, and a liquid crystal mixture containing a negative liquid crystal, a chiral dopant, a liquid crystal monomer and a photoinitiator is injected into the cell. The liquid crystal monomer and the chiral dopant enable the negative liquid crystal to form a cholesteric helical structure, wherein the cholesteric liquid crystal can reflect the infrared light. And then the first conductive light-transmitting substrate is connected to a negative pole of a power supply assembly, and the second conductive light-transmitting substrate is connected to a positive pole of the power supply assembly; the liquid crystal monomer and/or the chiral dopant captures impurity cations in the liquid crystal mixture so as to be positively charged, and then the positively charged liquid crystal monomer and/or the chiral dopant move towards the first conductive light-transmitting substrate to enable the concentration thereof to distribute in a gradient fashion in a direction perpendicular to the conductive light-transmitting substrate. As a result, the pitch of the cholesteric helical structure is distributed in a gradient fashion. The pitch in gradient distribution results in a wide bandwidth for reflecting infrared light. Ultraviolet light is used to irradiate the liquid crystal cell, and the photoinitiator initiates the liquid crystal monomer to polymerize so as to form a polymer network with a gradient density distribution in a direction perpendicular to the first conductive light-transmitting substrate. The negative liquid crystal is dispersed in the polymer network. At this time, the pitch remains gradient distribution after disconnecting the conductive light-transmitting substrates from the power supply assembly. If it is required to adjust the reflection waveband of the infrared reflective device, the first conductive light-transmitting substrate may be electrically connected to the positive pole of the power supply assembly and the second conductive light-transmitting substrate may be electrically connected to the negative pole of the power supply assembly. Since the liquid crystal monomer and/or the chiral dopant capture impurity cations in the liquid crystal mixture, the resulting polymer network also has the ability to capture impurity cations, so the polymer network is positively charged. The positively charged polymer network and/or the chiral dopant move towards the second conductive light-transmitting substrate, and the concentration difference of the polymer network is reduced in a direction perpendicular to the conductive light-transmitting substrate, and the movement of the polymer network drives the negative liquid crystal to move, so that the negative liquid crystal concentration gradient is reduced, the pitch gradient is decreased, and then the infrared reflection bandwidth is narrowed which will increase the transmission of infrared light.

### BRIEF DESCRIPTION OF THE DRAWINGS

FIG. 1 is a schematic view of a process for preparing an infrared reflective device; and

FIG. 2 is a schematic view of adjusting the infrared reflection waveband of an infrared reflective device.

### DETAILED DESCRIPTION

### Embodiment One

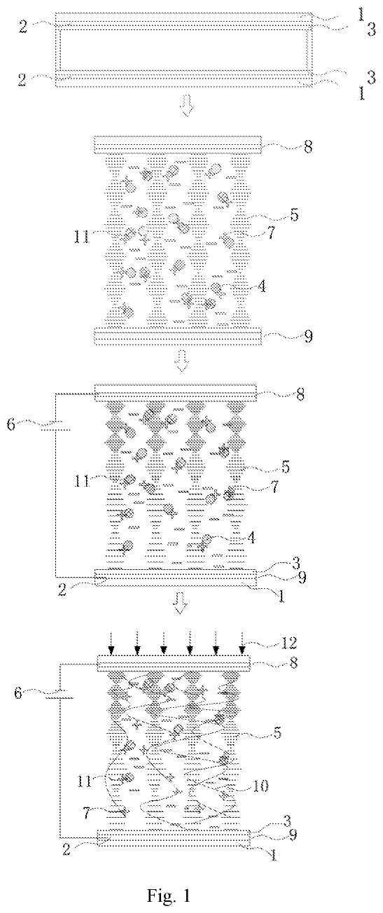

Referring to FIG. 1, an infrared reflective device is prepared according to the following steps. First, preparing a first conductive light-transmitting substrate 8 and a second conductive light-transmitting substrate 9 arranged opposite to the first conductive light-transmitting substrate 8. The first conductive light-transmitting substrate 8 and the second conductive light-transmitting substrate 9 each include a substrate 1. Each substrate 1 is coated with a conducting layer 2 on a respective surface facing the other substrate. Each of the first conductive light-transmitting substrate 8 and the second conductive light-transmitting substrate 9 is spin-coated with an alignment layer 3 at a respective side facing the other substrate, on which a parallel rubbing alignment is performed. That is, the alignment layer 3 is spin-coated on the conducting layer 2. The first conductive light-transmitting substrate 8 and the second conductive light-transmitting substrate 9 are prepared into a liquid crystal cell. A negative liquid crystal, a chiral dopant 4, a liquid crystal monomer 11, and a photoinitiator are weighed into a brown reagent bottle in a mass ratio of 81:13:5:1 and mixed by stirring. The brown bottle is heated to 60 degrees Celsius, and at the same time stirred uniformly at a speed of 40 revolutions per second to transform the mixture into a chiral nematic liquid crystal mixture with a decrease in viscosity. The liquid crystal monomer 11 and the chiral dopant 4 enable the negative liquid crystal to form a cholesteric helical structure 5, and then the liquid crystal mixture is injected into the liquid crystal cell, wherein the liquid crystal monomer 11 and the chiral dopant 4 both have an ester group capable of capturing impurity cations 7 in the liquid crystal mixture and enabling themselves to be positively charged. The liquid crystal monomer is at least one of RM82, RM257 and M04031. The chiral dopant is at least one of S811, R811, S1011, R1011 and ZLI-4572. The photoinitiator is either Irgacure-651 or Irgacure-369. The negative liquid crystal is at least one of MLC-2079, HNG708200-100 and HNG30400-200.

In this embodiment, the negative liquid crystal is MLC-2079 from Merck & Co., Germany, and the liquid crystal monomer 11 is RM82 from Merck & Co., Germany, with a structural formula:

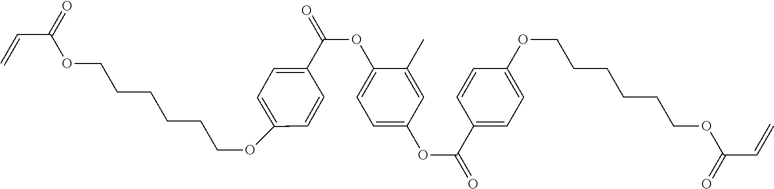 [SMILES: C=CC(=O)OCCCCCCOc1ccc(C(=O)Oc2ccc(OC(=O)c3ccc(OCCCCCCOC(=O)C=C)cc3)c(C)c2)cc1]

The chiral dopant 4 is S811 from Merck & Co., Germany, with a structural formula:

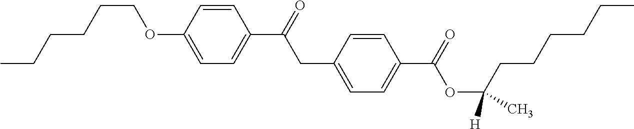 [SMILES: CCCCCCOc1ccc(C(=O)Cc2ccc(C(=O)O[C@@H](C)CCCCCC)cc2)cc1]

The photoinitiator is Irgacure-651, with a structural formula:

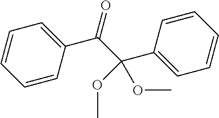 [SMILES: COC(OC)(C(=O)c1ccccc1)c1ccccc1]

Under the function of the parallel alignment layer 3, an axis of the cholesteric helical structure 5 is perpendicular to the first conductive light-transmitting substrate 8. The first conductive light-transmitting substrate 8 is connected to a negative pole of a power supply assembly 6, and the second conductive light-transmitting substrate 9 is connected to a positive pole of the power supply assembly 6. The liquid crystal monomer 11 and the chiral dopant 4 each have an ester group capable of capturing impurity cations 7 in the liquid crystal mixture and enabling the liquid crystal monomer 11 and the chiral dopant 4 to have positive charges. The positively charged liquid crystal monomer 11 and the chiral dopant 4 then move towards the first conductive light-transmitting substrate 8, such that the concentration of the liquid crystal monomer 11 and the concentration of the chiral dopant 4 both decrease gradually in a direction from the first conductive light-transmitting substrate 8 to the second conductive light-transmitting substrate 9, that is, there exists a concentration gradient for each of the liquid crystal monomer 11 and the chiral dopant 4.

According to HTP=1/Pc (1), where HTP is a spirally twisted force, P is a pitch and c is a mass fraction of the chiral dopant 4, it can be concluded that a concentration gradient is present in the chiral dopant 4 when the total mass remains unchanged, resulting in a mass fraction gradient thereof. According to the formula (1), a pitch gradient of the cholesteric liquid crystal can be then formed. According to Δλ=(nₑ−nₒ)×P=Δn×P (2), where nₑ is an ordinary refractive index, nₒ is an extraordinary refractive index, An is a difference between the refractive indexes, and Δλ, is a bandwidth of a reflection spectrum, it can then be concluded in combination with the formula (1) that the concentration gradient present in the chiral dopant 4 can result in a wider reflection bandwidth.

By using ultraviolet light 12 to irradiate the liquid crystal cell in any directions while maintaining an electrical connection of the first conductive light-transmitting substrate 8 to the negative pole of the power supply assembly 6 and an electrical connection of the second conductive light-transmitting substrate 9 to the positive pole of the power supply assembly 6, the photoinitiator initiates the liquid crystal monomer 11 to polymerize to form a polymer network 10. The concentration gradient present in the liquid crystal monomer 11 results in a density gradient in the polymer network 10. The polymer network 10 is relatively dense at one side adjacent to the first conductive light-transmitting substrate 8 so that the pitch of the chiral nematic liquid crystal can be compressed, and the polymer network 10 is relatively loose at the other side adjacent to the second conductive light-transmitting substrate 9 so that the pitch of the chiral nematic liquid crystal can be stretched. The concentration gradient in the chiral dopant 4 and the concentration in the polymer network 10 collectively cause a pitch gradient, so that the infrared reflective device has a wider bandwidth which can reflect more infrared light, which is beneficial for reducing the indoor temperature.

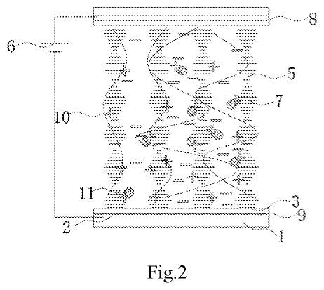

If it is required to adjust the reflection waveband of the infrared reflective device, as shown in FIG. 2, the first conductive light-transmitting substrate 8 may be electrically connected to the positive pole of the power supply assembly 6 and the second conductive light-transmitting substrate 9 may be electrically connected to the negative pole of the power supply assembly 6. The positively charged chiral dopant 4 and the polymer network 10 both then move towards the second conductive light-transmitting substrate 9 causing a pitch reduction in the cholesteric liquid crystal. As a result, the infrared reflection waveband is narrowed which can reduce the infrared reflection, which is beneficial for increasing indoor temperature.

### Embodiment Two

This embodiment is substantially identical to the embodiment one, except that a mass ratio of the negative liquid crystal, the chiral dopant, the photopolymerizable monomer and the photoinitiator is 79.5:14.5:5:1. The liquid crystal monomer is RM257 and has an ester group capable of capturing cation. The chiral dopant is R811. The photoinitiator is Irgacure-369 with a structural formula:

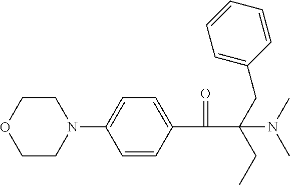 [SMILES: CCC(Cc1ccccc1)(C(=O)c1ccc(N2CCOCC2)cc1)N(C)C]

The negative liquid crystal is HNG30400-200. The ultraviolet light irradiates the liquid crystal cell from the first conductive light-transmitting substrate.

### Embodiment Three

This embodiment is substantially identical to the embodiment one, except that a mass ratio of the negative liquid crystal, the chiral dopant, the photopolymerizable monomer and the photoinitiator is 80.4:13.6:5:1. The chiral dopant has an ester group capable of capturing cation. The liquid crystal monomer is M04031. The chiral dopant is S1011. The photoinitiator is Irgacure-369. The negative liquid crystal is HNG708200-100.

1. A method for preparing an infrared reflective device, comprising:
S1: preparing a first conductive light-transmitting substrate and a second conductive light-transmitting substrate, the first conductive light-transmitting substrate and the second conductive light-transmitting substrate being arranged opposite to each other;
S2: spin-coating an alignment layer on each of a surface of the first conductive light-transmitting substrate facing the second conductive light-transmitting substrate and a surface of the second conductive light-transmitting substrate facing the first conductive light-transmitting substrate, and performing parallel rubbing alignment;
S3: preparing a liquid crystal cell using the first conductive light-transmitting substrate and the second conductive light-transmitting substrate;
S4: uniformly mixing and heating a negative liquid crystal, a chiral dopant, a liquid crystal monomer and a photoinitiator to obtain a liquid crystal mixture;
S5: injecting the liquid crystal mixture into the liquid crystal cell, the liquid crystal monomer and the chiral dopant enabling the negative liquid crystal to form into a cholesteric helical structure;
S6: connecting the first conductive light-transmitting substrate to a negative pole of a power supply assembly, connecting the second conductive light-transmitting substrate to a positive pole of the power supply assembly, at least one of the liquid crystal monomer and the chiral dopant capturing impurity cations in the liquid crystal mixture to be positively charged to move towards the first conductive light-transmitting substrate; and
S7: using ultraviolet light to irradiate the liquid crystal cell, thereby the liquid crystal monomer is initiated by the photoinitiator to be polymerized so as to form a polymer network with a gradient density distribution in a direction perpendicular to the first conductive light-transmitting substrate, the negative liquid crystal being dispersed in the polymer network.

2. The method for preparing an infrared reflective device according to claim 1, wherein at least one of the liquid crystal monomer and the chiral dopant has an ester group capable of capturing cation.

3. The method for preparing an infrared reflective device according to claim 1, wherein the liquid crystal monomer is at least one of RM82, RM257 and M04031.

4. The method for preparing an infrared reflective device according to claim 1, wherein the chiral dopant is at least one of S811, R811, S1011, R1011, ZLI-4572.

5. The method for preparing an infrared reflective device according to claim 1, wherein the photoinitiator is Irgacure-651 or Irgacure-369.

6. The method for preparing an infrared reflective device according to claim 1, wherein the negative liquid crystal is at least one of MLC-2079, HNG708200-100, HNG30400-200.

7. The method for preparing an infrared reflective device according to claim 1, wherein the ultraviolet light irradiates the liquid crystal cell from the first conductive light-transmitting substrate.

8. The method for preparing an infrared reflective device according to claim 1, wherein both the first conductive light-transmitting substrate and the second conductive light-transmitting substrate comprise a substrate, and each substrate is coated with a conducting layer on a respective surface facing the other substrate.
